(19) United States
(12) Patent Application Publication
(10) Pub. No.: US 2005/0015355 A1
(43) Pub. Date: Jan. 20, 2005

(54) Method and system for data sharing between application programs

(75) Inventors: David Heller, San Jose, CA (US); Jeffrey L. Robbin, Los Altos, CA (US); Glenn Reid, Woodside, CA (US)

Correspondence Address: BEYER WEAVER & THOMAS LLP, P.O. BOX 778, BERKELEY, CA, 94704-0778, US

(73) Assignee: Apple Computer, Inc.

(21) Appl. No.: 10/622,017

(22) Filed: Jul. 16, 2003

(51) Int. Cl. G06F 7/00; G06F 9/46

(52) U.S. Cl. 707/1; 719/328

(57) ABSTRACT

Techniques for sharing data with other application programs are disclosed. The techniques allow data sharing between different application programs on a computer system. For instance, a second application program can access data provided by a first application program without needing the first application program to be operating or executing on the computer system. In one embodiment, an application operates to publish its data for external use by other application programs. The data is, for example, database data maintained by the application program. The data can be published for external use by producing a data communication file that contains at least a portion of the data. In one implementation, the data communication file contains the data being published for external use in a markup language representation. The techniques are particularly well suited for application programs that utilize databases to store media information pertaining to media items. The media information can include properties of the media items as well as links to storage locations for corresponding media content files that store the media content. The media content is, for example, one or more of audio, images or video.

### BACKGROUND OF THE INVENTION

1. Field of the Invention

The present invention relates to computers and, more particularly, to sharing data between application programs.

2. Description of the Related Art

A user of a computer system often desires to navigate a file system of the computer system to locate a particular file to be executed, deleted, copied or moved. Conventionally, a file dialog box is displayed on a display screen to assist the user in locating the particular file. For example, when a user desires to locate a previously stored image file (e.g., JPEG formatted file), the user will typically navigate through the file system using a file dialog box. In Microsoft Windows™, the user might look in “My Pictures” folder when seeking to insert a picture into a windows-based program (e.g., Microsoft Windows™). In Apple's OS X, the user might use a finder to locate a picture to insert into an application program. In either case, since the file names are often largely non-descriptive, a preview of a selected image may be displayed to assist the user in locating the desired file.

A database program is not normally able to simply read a database created by another database program, unless the database formats (e.g., layouts) are the same or otherwise understood. Databases have, however, been able to import or export their data using files. This typically involves a user-initiated task of first exporting database data to a file, and then subsequently importing the database data into another database using the file. This export-import routine is thus tedious and not suitable to automated operation. If one application program were permitted to directly access another program's data, e.g., database, the access could be performed without user participation. Unfortunately, however, such direct access would require that the data format (e.g., layout) of the database be released to others. If the data format is proprietary, it may not be desirable to release the data format. Further, releasing the data format of a database can hamper subsequent revisions to the data format.

Thus, there is a need for improved ways to exchange data between different application programs without having to permit direct access to the application data.

### SUMMARY OF THE INVENTION

Broadly speaking, the invention pertains to techniques for sharing data with other application programs. The techniques allow data sharing between different application programs on a computer system. A second application program can access data provided by a first application program without requiring the first application program to be executing or running on the computer system. In one embodiment, an application operates to publish its data for external use by other application programs. The data is, for example, database data maintained by the application program. The data can be published for external use by producing a data communication file that contains at least a portion of the data. In one implementation, the data communication file contains the data being published for external use in a markup language representation.

The invention is particularly well suited for application programs that utilize databases to store media information pertaining to media items. The media information can include properties of the media items as well as links to storage locations for corresponding media content files that store the media content. The media content is, for example, one or more of audio, images or video. Hence, the application programs can be referred to as multimedia application programs, and/or the databases can be referred to as multimedia databases.

The invention can be implemented in numerous ways, including as a method, system, device, apparatus, or computer readable medium. Several embodiments of the invention are discussed below.

As a method for sharing media data between application programs operating (e.g., executing running) on at least one computer system, the computer system having a display and a data storage device, one embodiment of the invention includes at least the acts of: accessing, by a second application program, a data communication file provided by a first application program; producing a user interface on the display using data from the data communication file; receiving a user selection with respect to the user interface; identifying a media content file associated with the user selection; and associating a media content file identified by the user selection to the second application program.

As a computer readable medium including at least computer program code for sharing media data between application programs operating on at least one computer system, one embodiment of the invention includes at least: computer program code for accessing, by a second application program, a data communication file provided by a first application program; computer program code for producing a user interface using data from the data communication file; computer program code for receiving a user selection with respect to the user interface; computer program code for identifying a media content file associated with the user selection; and computer program code for associating a media content file identified by the user selection to the second application program.

As a computer system for sharing media data between application programs operating thereon, one embodiment of the invention includes at least: a first application program that manages a first media database that contains at least media information pertaining to media items, the first application further produces a database data communication file that includes at least a portion of the media information of the first media database; a data storage device that stores the database data communication file and a media content file for each of a plurality of media items; and a second application program that presents a user interface using at least a portion of the media information acquired from the database data communication file.

Other aspects and advantages of the invention will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, wherein like reference numerals designate like structural elements, and in which:

FIG. 1 is a block diagram of a multimedia computer system according to one embodiment of the invention.

FIG. 2 is a flow diagram of a database update process according to one embodiment of the invention.

FIG. 3 is a flow diagram of an inter-application data communication process according to one embodiment of the invention.

FIG. 4 is a block diagram of an inter-application data communication system according to one embodiment of the invention.

FIG. 5 is a flow diagram of a database update process according to one embodiment of the invention.

FIGS. 6A and 6B are flow diagrams of a user interface generation process according to one embodiment of the invention.

FIG. 7 is a screen shot of a user interface from a representative audio-based application program.

FIG. 8 is a screen shot of a user interface from a representative image-based application program.

### DETAILED DESCRIPTION OF THE INVENTION

The, invention pertains to techniques for sharing data with other application programs. The techniques allow data sharing between different application programs on a computer system. A second application program can access data provided by a first application program without requiring the first application program to be executing or running on the computer system. In one embodiment, an application operates to publish its data for external use by other application programs. The data is, for example, database data maintained by the application program. The data can be published for external use by producing a data communication file that contains at least a portion of the data. In one implementation, the data communication file contains the data being published for external use in a markup language representation.

The invention is particularly well suited for application programs that utilize databases to store media information pertaining to media items. The media information can include properties of the media items as well as links to storage locations for corresponding media content files that store the media content. The media content is, for example, one or more of audio, images or video. Hence, the application programs can be referred to as multimedia application programs, and/or the databases can be referred to as multimedia databases.

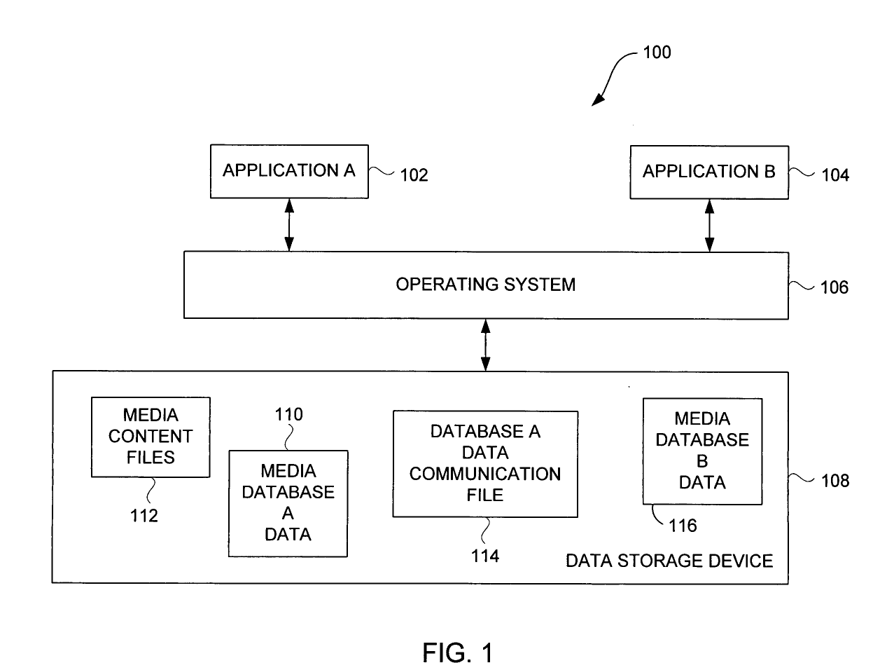

Embodiments of this aspect of the invention are discussed below with reference to FIGS. 1-8. However, those skilled in the art will readily appreciate that the detailed description given herein with respect to these figures is for explanatory purposes as the invention extends beyond these limited embodiments.

FIG. 1 is a computer system 100 according to one embodiment of the invention. The computer system 100 facilitates communication between multiple applications that may operate on the computer system 100. The computer system 100 can, for example, be a general purpose computer (e.g., personal computer, such as a desktop computer or a portable computer). The multiple applications can often relate to media (or media content), such as audio, images or video; hence, the computer system 100 could also be referred to as a multimedia computer system.

The computer system 100 includes an application A 102 and an application B 104. The applications 102 and 104 are separate applications (application programs) that can be activated or executed on the computer system 100. These applications 102 and 104 can be considered “sister” applications because they are able to share data with one another, without requiring that both applications be executing or running on the computer system 100.

The applications 102 and 104 couple to an operating system 106. The operating system then couples to a data storage device 108. The data storage device 108 stores data (or files) that are utilized by the computer system 100. In particular, the data (or files) stored to the data storage device are utilized by one or both of the applications 102 and 104.

More particularly, the data storage device 108 stores media database A data 110. Here, the application A 102 uses a media database A, and thus the data storage device 108 operates to provide non-volatile storage for the media database A data 110. The media database A contains media information pertaining to media items. These media items, in turn, have their content stored in media content files. The data storage device 108 also stores media content files 112.

The data storage device 108 also stores a database A data communication file 114 which is a file that contains media information that corresponds to like information within the media database A. The database A data communication file 114 allows the application A 102, or its media database A, to share some or all of the information from the media database A to other applications. Here, the media information contained in the media database A data communication file 114 can be utilized by the application B 104. The application B 104 is able to make use of the database A data communication file 114 regardless of whether the application A 102 is being executed or otherwise running within the computer system 100. Finally, the data storage device 108 includes media database B data 116 that is associated with a media database B provided or maintained by the application B 104.

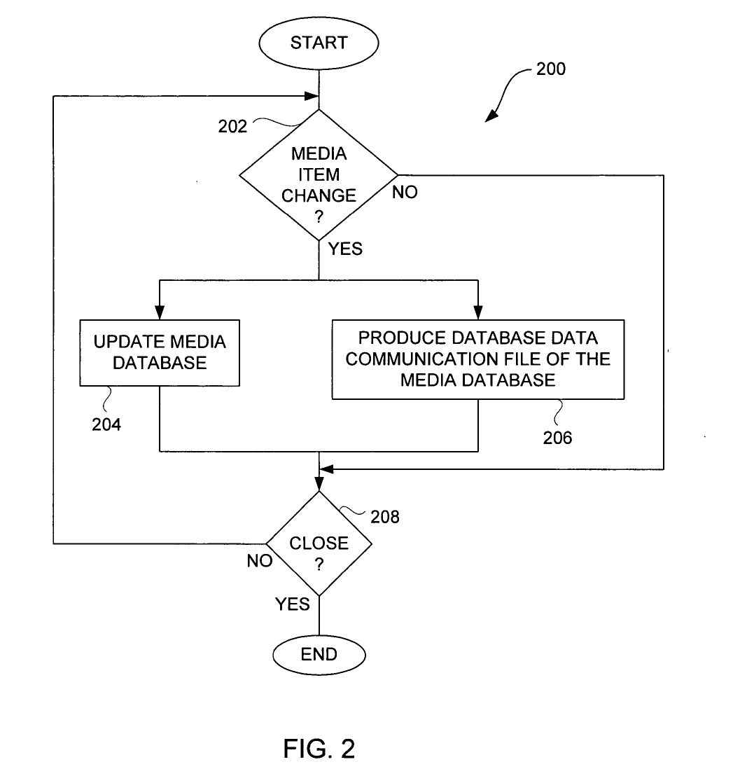

FIG. 2 is a flow diagram of a database update process 200 according to one embodiment of the invention. The database update process 200 is, for example, performed by an application program, such as the application A 102 illustrated in FIG. 1.

The database update process 200 begins with a decision 202 that determines whether a media item has changed. Here, the decision 202 determines whether a media item has been added to or modified with respect to a media database (e.g., media database A) maintained by the application program. When the decision 202 determines that a media item has changed, then the media database is updated 204. Here, the media database is updated 204 to include the change to the media item. The change to the media item may, for example, be the addition of a new media item or may be a modification to an existing media item. Additionally, when the decision 202 determines that a media item has changed, a database data communication file of the media database is produced 206. The database data communication file allows the application to share its data with other applications. In other words, the data is published for external use via the data communication file. In one embodiment, the database data communication file is provided as a markup language representation. As an example, the markup language representation can be a markup language file (document) such as extensible Markup Language (XML). The operations 204 and 206 can be performed in serially or in parallel.

Following the operations 204 and 206, the database update process 200 considers a decision 208 as to whether the database update process 200 should be closed. The database update process 200 also performs the decision 208 when the decision 202 determines that there has been no change to a media item. When the decision 208 determines that the database update process should not close, then the database update process 200 returns to repeat the decision 202 and subsequent operations. On the other hand, when the decision 208 determines that the database update process 200 should close, then the database update process 200 is complete and ends.

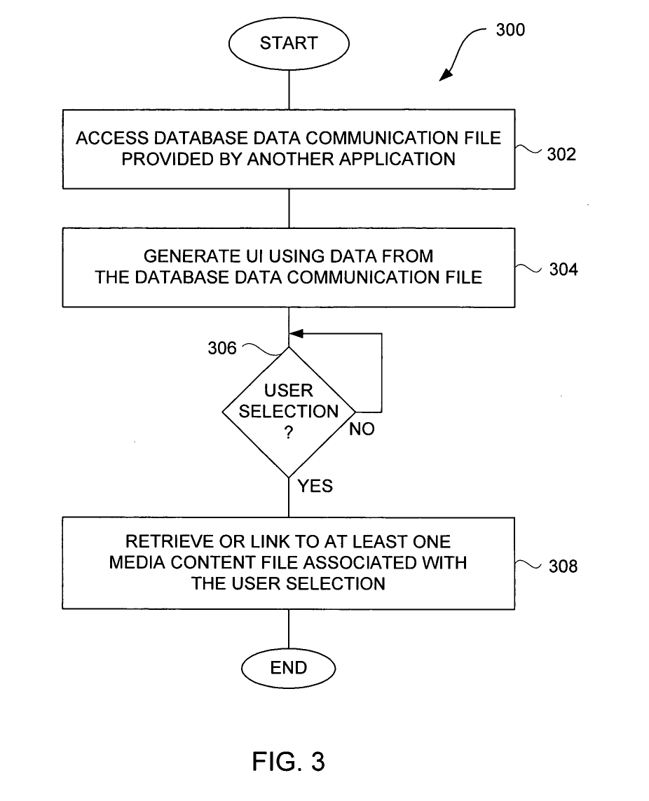

FIG. 3 is a flow diagram of an inter-application data communication process 300 according to one embodiment of the invention. The inter-application data communication process 300 is, for example, performed by an application program, such as the application B 104 illustrated in FIG. 1.

The inter-application data communication process 300 accesses 302 a database data communication file provided by another application. Here, for example, when the inter-application data communication process 300 is performed by the application B 104, then a database data communication file being accessed 302 is maintained by the application A 102 (see, e.g., block 206, FIG. 2). After the database data communication file has been accessed 302, a user interface (UI) is generated 304 using data from the database data communication file. As an example, the user interface being generated 304 can be displayed to a user by way of a monitor (or display) of a computer system.

Next, a decision 306 determines whether a user selection has been made. When the decision 306 determines that a user selection has been made, then the user selection with respect to the user interface is processed. Namely, at least one media content file associated with the user selection is linked to or retrieved 308. Following the operation 308, the inter-application data communication process 300 is complete and ends.

The user interface 304 being generated by the inter-application data communication process 300 can vary widely with implementation. In one implementation, the user interface 304 includes at least a list (e.g., menu) of items (e.g., media items) obtained from the database data communication file. Additionally, the user interface 304 can also resemble a user interface provided by the other application. The resemblance can pertain to the overall look of a user interface element (e.g., list), and/or to the media items (and their organization) within the user interface element. The ability to present a consistent user interface across different applications is helpful to improve the user's experience.

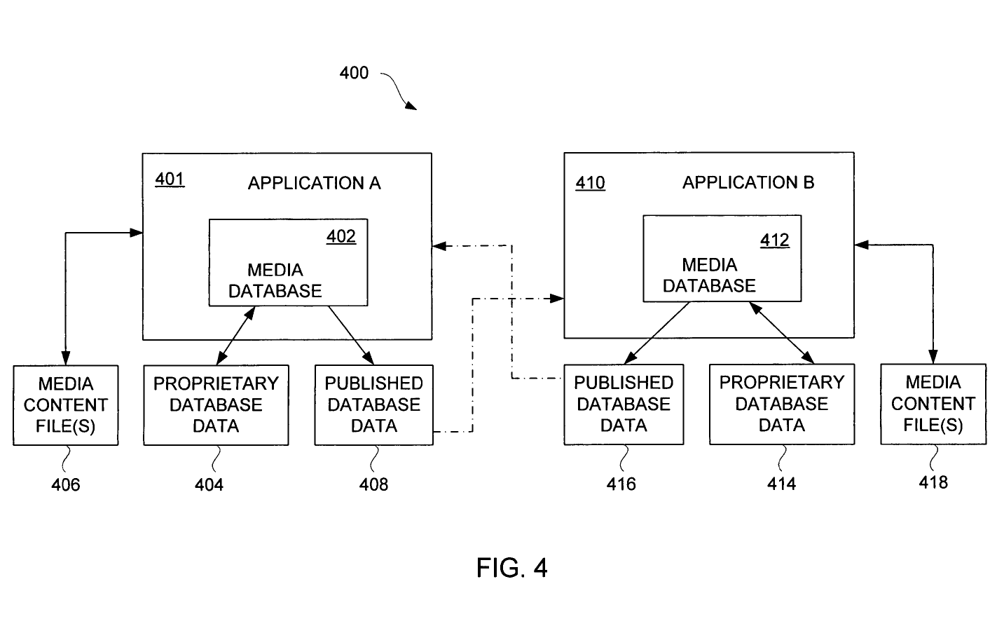

FIG. 4 is a block diagram of an inter-application data communication system 400 according to one embodiment of the invention. The inter-application data communication system 400 can, for example, represent a more detailed embodiment of the computer system 100 illustrated in FIG. 1. In any case, the inter-application data communication system 400 allows data from one application (application program) to be used by another application. Although the application operates on a computer system, the inter-application data sharing can be achieved without regards as to whether the application that has provided the data is executing or running on the computer system. The computer system can, for example, be a general purpose computer (e.g., personal computer, such as a desktop computer or a portable computer). Also, the multiple applications can often relate to media (or media content), such as audio, images or video; hence, the computer system could also be referred to as a multimedia computer system.

The inter-application data communication system 400 includes an application A 401 that maintains a media database 402. The application A 401 stores the media database 402 as proprietary database data 404. In addition, to facilitate sharing of the database data, the application A 401 also stores some or all of the media information from the media database 402 as published database data 408. The application A 401 also has access to media content files 406. The media information within the media database 402 pertains to the media items that have their media content stored in the media content files 406. The proprietary database data 404, the media content files 406 and the published database data 408 can be stored within one or more data storage devices.

The inter-application data communication system 400 also includes an application B 410. The application B 410 includes a media database 412. The media database contains media information pertaining to media items. The application B 410 maintains the media database 412 and stores media information for the media database 412 as proprietary database data 414. The application B 410 can also store some or all of the media information from the media database 412 as published database data 416. The published database data 416 is provided to facilitate sharing of the media information from the media database 412 to other applications. Moreover, the application B 410 has access to media content files 418. The media content files 418 store media content associated with the media items within the media database 412.

With respect to the inter-application data communication system 400, the media information from the media database 402 of the application A 401 can be utilized by the application B 410, regardless of whether the application A 401 is executing or running at the time at which the data is to be acquired. Specifically, the application A 401 produces the published database data 408. The application B 410 is aware of the location of the published database data 408 and is thus able to access the published database data 408. Thereafter, the application B 410 can interpret the published database data 408 and make use of such data at the application B 410. The use of the published database data 408 can, for example, be used to produce a user interface that allows interaction with respect to the media items from the media database 402 associated with the application A 401 while interacting with the application B 410. Although the specifics of the user interface can widely vary, in one implementation, the user interface can include at least a list (e.g., menu) of items (e.g., media items) obtained from the published database data 408. Additionally, the user interface can also resemble a user interface provided by the other application A 401.

Similarly, the application B 410 produces the published database data 416 that pertains to the media database 412 of the application B 410. The application A 401 can make use of the published database data 416 in much the same manner as previously noted. The application A 401 and the application B 410 can be considered “sister” applications because they are able to share data with one another, without requiring that both applications be executing or active on the computer system.

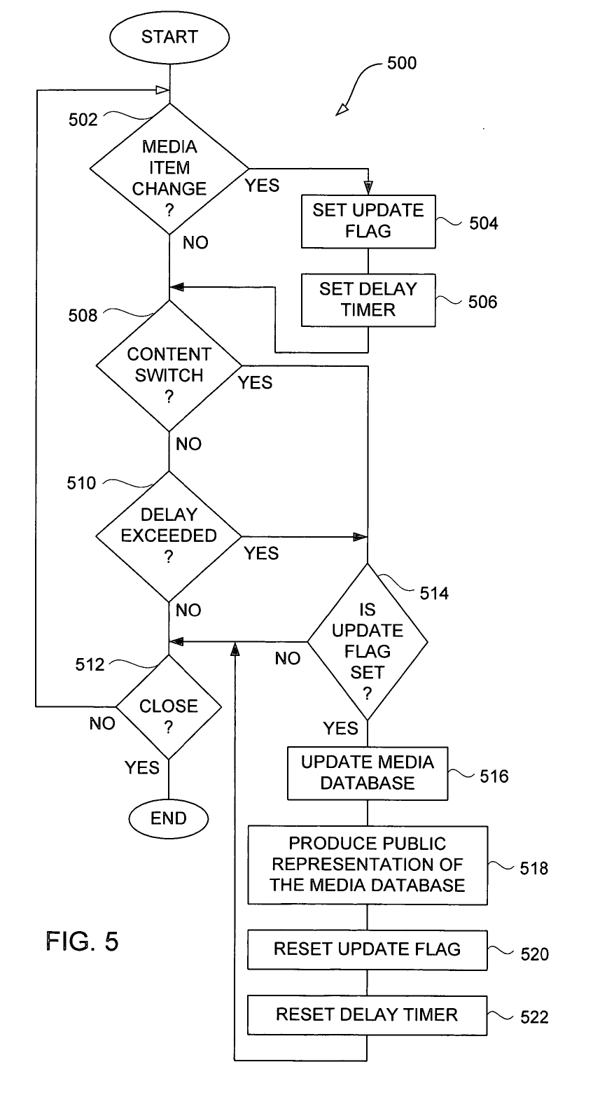

FIG. 5 is a flow diagram of a database update process 500 according to one embodiment of the invention. The database update process 500 is, for example, processing that would be performed by the application A 401 or the application B 410 shown in FIG. 4.

The database update process 500 begins with a decision 502 that determines whether a media item has changed. Here, the decision 502 determines whether a media item associated with the media database has changed such that it would be advantageous to update the media database. For example, a media item change could be the alteration of an existing media item or its organization with respect to other media items, or the addition of a new media item, or the deletion of an existing media item. In any case, when the decision 502 determines that a media item has changed, an update flag is set 504. In addition, a delay timer is set 506. The delay timer provides a delay period (interval), such as 10 seconds, during which updates are not performed, so as to regulate the frequency at which updates can occur.

Following the operation 506, or directly following the decision 502 when there is no media item change, a decision 508 determines whether a context switch has occurred. Here, the context switch can occur when a running application is switched from a background to a foreground position as is common with windows-based applications and/or operating systems. When the decision 508 determines that a context switch has not occurred, then a decision 510 determines whether the delay period (interval) has been exceeded. When the decision 510 determines that the delay period has not been exceeded, then a decision 512 determines whether the database update process 500 should close. When the decision 512 determines that the database update process 500 should not close, then the database update process 500 returns to repeat the decision 502 and subsequent operations.

On the other hand, when the decision 508 determines that a context switch has occurred or when the decision 510 determines that the delay period has been exceeded, then a decision 514 determines whether the update flag is set. When the decision 514 determines that the update flag is set, then processing is performed to update a data communication file (published database data). Specifically, the media database is updated 516. The updating of the media database causes the media item change to be reflected in the media database. In addition, public representation of the media database is produced 518. The public representation of the media database, for example, contains published database data (e.g., published database data 408 or 416 of FIG. 4). The public representation of the media database is also normally contained within a file (electronic file), which may be referred to as a data communication file. In one implementation, the public representation of the media database can pertain to a public, shared database. In another implementation, the public representation of the media database can be a markup language representation of the media database. One example of a markup language representation would be an XML representation. In still another implementation, the public representation can be a binary data format. Furthermore, the update flag is reset 520, and the delay timer is reset 522.

Following the operation 522, as well as following the decision 514 when the update flag is not set, the decision 512 is performed. When the decision 512 determines that the database update process should not close, the database update process 500 returns to repeat the decision 502 and subsequent operations as previously noted. On the other hand, when the decision 512 determines that the database update process 500 should close, then the database update process 500 is complete and ends.

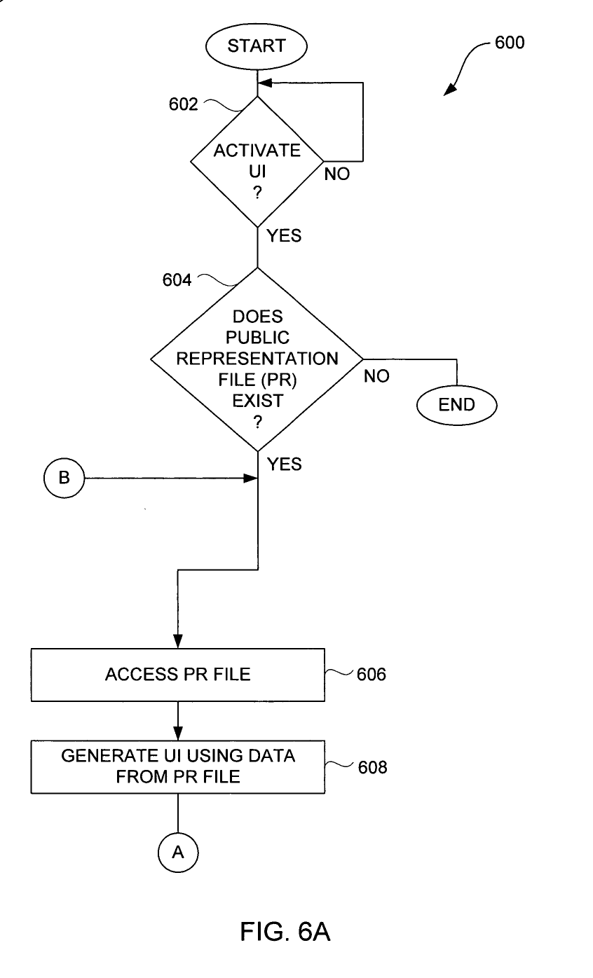

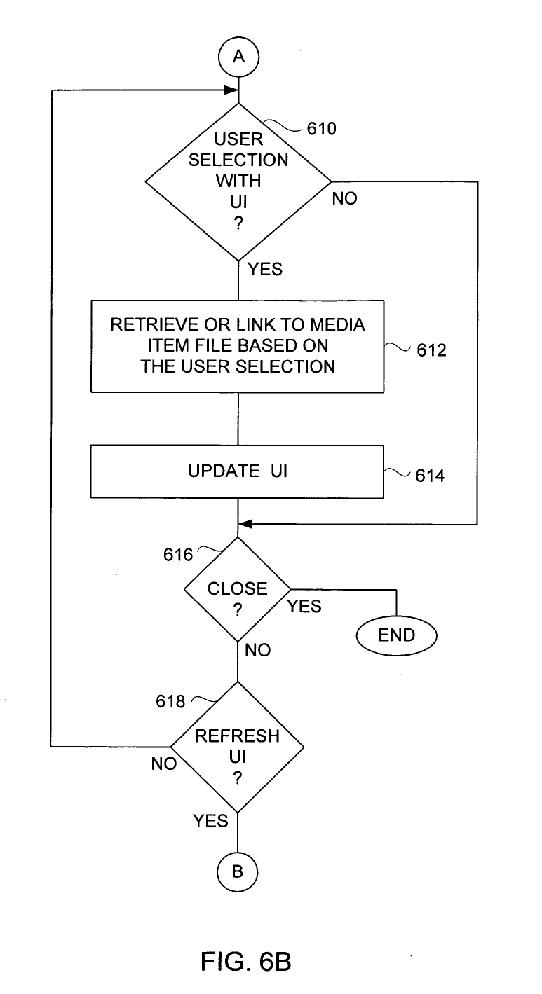

FIGS. 6A and 6B are flow diagrams of a user interface generation process 600 according to one embodiment of the invention. The user interface generation process 600 causes a user interface to be produced using shared data from another application.

The user interface generation process 600 begins with a decision 602 that determines whether a user interface is active. When the user interface (UI) is not active, then the user interface generation process 600 awaits activation of the user interface. Examples of activation include launching the application program or refreshing a user interface provided by the application program. When the decision 602 determines that the user interface is active, a decision 604 determines whether a public representation (PR) file exists. The public representation file is available for external use (e.g., by other application programs). For example, as noted above in FIG. 5, the public representation file can pertain to a public, shared database, can be a markup language representation of the media database, or can be a binary data format. In any case, when the decision 604 determines that a public representation file does not exist, then the user interface generation process 600 is complete and ends. In one implementation, the decision 604 will retry once or a few additional times to ensure that the public representation file does not exist only for a trivial duration.

Alternatively, when the decision 604 determines that the public representation file does exist, then the public representation file is accessed 606. Here, some or all of the information stored within the public representation file can be read into memory for use by the application program. Next, a user interface (UI) is generated 608 using the data obtained from the markup language representation file. In one implementation, the UI is produced and displayed (or otherwise presented) having one or more media items presented in a list (e.g., menu). A decision 610 then determines whether a user selection with respect to the user interface has been made. When the decision 610 determines that a user selection has been made, a media item file is linked to or retrieved 612 based on the user selection. The application can then operate to present (e.g., display, play, view) the media content from the media item file to the user. In addition, the user interface can be updated 614 in response to the user selection.

Next, a decision 616 determines whether the user interface generation process 600 should close. When the decision 616 determines that the user interface generation process 600 should close, then the user interface generation process 60Q is complete and ends. On the other hand, when the decision 616 determines that the user interface generation process 600 should not close, then a decision 618 determines whether the user interface should be refreshed. Here, the decision 618 can determine to refresh the user interface when an update to the associated media database has occurred, or may have occurred, such as when the public representation file has been updated or following a context switch. In any case, when the decision 618 determines that the user interface should be refreshed, the user interface generation process 600 returns to repeat the operation 606 and subsequent operations so that the user interface can be refreshed. Alternatively, when the decision 618 determines that the user interface does not need to be refreshed, then the user interface generation process 600 returns to repeat the decision 610 and subsequent operations to await a user selection with respect to the user interface.

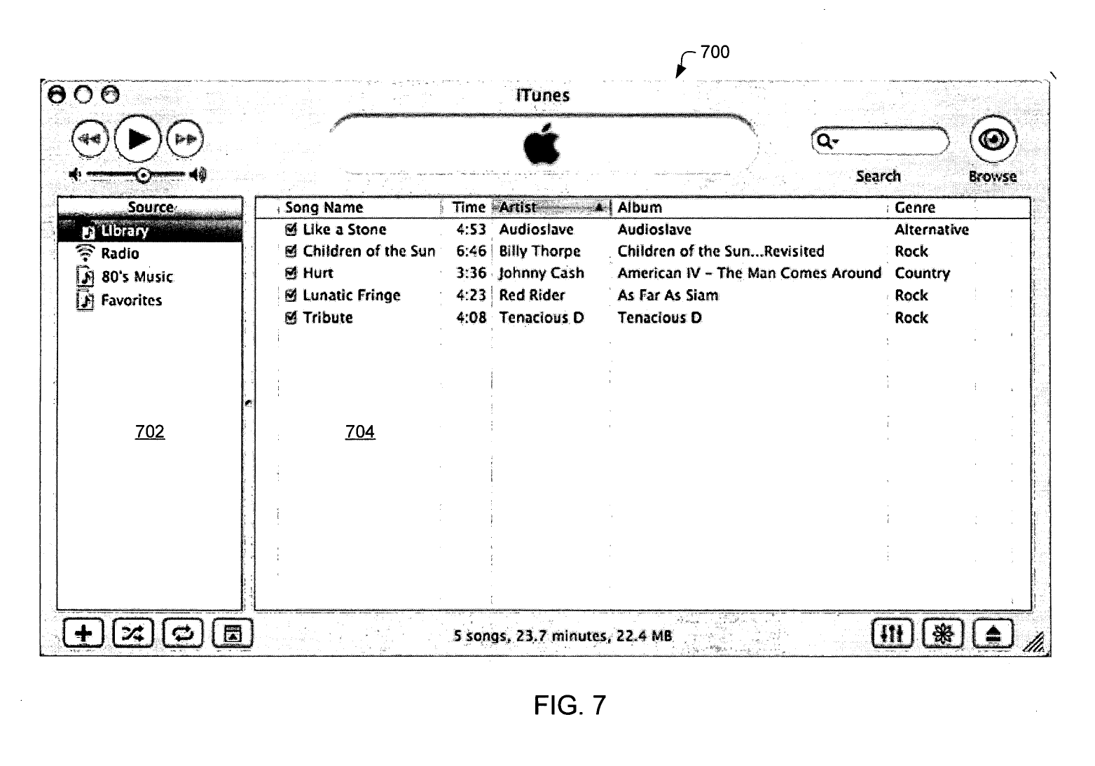

FIG. 7 is a screen shot of a user interface 700 from a representative audio-based application program. The representative audio-based application program in this example is iTunes™ from Apple Computer, Inc. The user interface 700 includes a source pane 702 and a media item list pane 704. The source pane 702 indicates the selection of the “Library” source for media items. The media item list pane 704 displays a list of those media items (e.g., audio items, namely songs) available in the “Library” source. As illustrated in FIG. 7, the list of the songs in the media item list pane 704 includes five (5) songs, and provides media item information (Song Name, Time, Artist, Album and Genre) for each of the songs. Hence, iTunes would maintain it own private database with the list of media items and the media item information therefore. Additionally, according to the invention, iTunes would, as discussed above, produce a public representation of the private database for access by other applications.

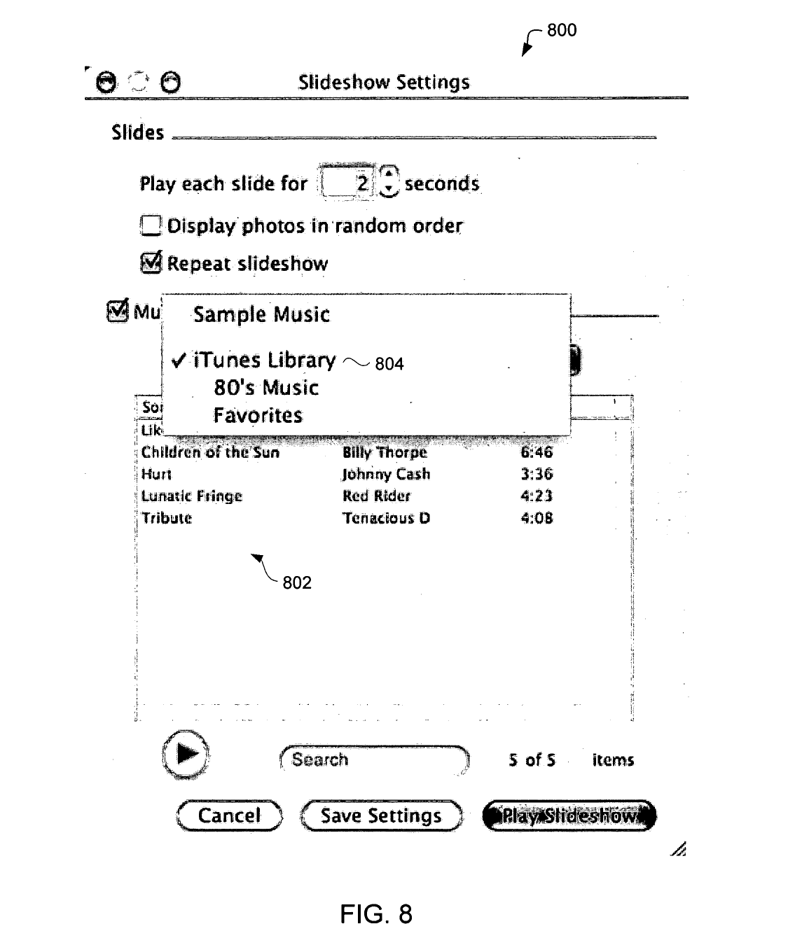

FIG. 8 is a screen shot of a user interface 800 from a representative image-based application program. The representative image-based application program in this example is iPhoto™ from Apple Computer, Inc. The user interface 800 involves configuring slideshows settings. A slideshow of images (e.g., photos) are able to be arranged and then subsequently played for viewers. Here, the user interface 800 allows the users to set a play duration for each slide as well as to add music to the slideshow. However, iPhoto does not itself manage music content, but iTunes does. When both these program reside on the same computer, they can share of or all of there media databases using the inventive techniques discussed above. Here, the user interface 800 presented within the iPhoto application contains a list 802 of selectable music songs (media items). This list 802 of songs is associated with an iTunes Library 804 given the selection of a sample music source. The list 802 has five (5) songs and the media information for each includes Song Name, Artist and Time. The list 802 of songs thus is created using the public representation of the private (iTunes) database of iTunes, which is a different application. Note that the list 802 of songs shown in FIG. 800 as presented by the iPhoto application resembles the list of the songs in the media item list pane 704 shown in FIG. 7 as presented by the iTunes application.

Although much of the above discussion pertains to a single computer system having multiple applications, it should be understood that the invention can equally apply to a system of computers. For example, with the inter-application data communication system 400, the application A 401 can be executed on a first computer and the application B 410 can be executed on a second computer. In general, the application desirous of inter-application data communication need to agree to a location for the published database data. Still further, the published database data need not reside on the same machines as any of the applications.

More generally, application programs (e.g., multimedia application programs) used with the invention can be media management and player/viewer programs. For example, from Apple Computer, Inc., iTunes can be considered a music manager and player, iPhoto can be considered a photo manager and viewer, and iMovie™ or iDVD™ can be considered a video manager and viewer. These application programs from Apple Computer, Inc. are part of their iLife™ series and can be considered “sister” application.

The various aspects, features, embodiments or implementations of the invention described above can be used alone or in various combinations.

The invention is preferably implemented by software, hardware or a combination of hardware and software. The invention can also be embodied as computer readable code on a computer readable medium. The computer readable medium is any data storage device that can store data which can thereafter be read by a computer system. Examples of the computer readable medium include read-only memory, random-access memory, CD-ROMs, DVDs, magnetic tape, optical data storage devices, and carrier waves. The computer readable medium can also be distributed over network-coupled computer systems so that the computer readable code is stored and executed in a distributed fashion.

The advantages of the invention are numerous. Different embodiments or implementations may yield one or more of the following advantages. One advantage of the invention is that database data can be seamlessly shared between application programs. Another advantage of the invention is that a second application program can access a first application's database data and present a user interface that resembles a user interface that is used by the first application program. Still another advantage of the invention is that the application program that originated the database data need not be executing or running in order for another application program to gain access to the database data being shared.

The many features and advantages of the present invention are apparent from the written description and, thus, it is intended by the appended claims to cover all such features and advantages of the invention. Further, since numerous modifications and changes will readily occur to those skilled in the art, the invention should not be limited to the exact construction and operation as illustrated and described. Hence, all suitable modifications and equivalents may be resorted to as falling within the scope of the invention.

1. A method for sharing media data between application programs operating on at least one computer system, the computer system having a display and a data storage device, said method comprising:
(a) accessing, by a second application program, a data communication file provided by a first application program;
(b) producing a user interface on the display using data from the data communication file;
(c) receiving a user selection with respect to the user interface;
(d) identifying a media content file associated with the user selection; and
(e) associating a media content file identified by the user selection to the second application program.

2. A method as recited in claim 1, wherein the data within the data communication file includes a link to the media content file.

3. A method as recited in claim 1, wherein the media content file is stored in the data storage device by the first application program, and thereafter the media content file is useable by the second application program.

4. A method as recited in claim 1, wherein said associating (e) comprises presenting the media content file at the computer system.

5. A method as recited in claim 1, wherein said associating (e) comprises playing or displaying, within the second application program on the computer system, media content from the media content file.

6. A method as recited in claim 1, wherein the user interface includes at least a menu of media items determined from data acquired from the data communication file provided by the first application program.

7. A method as recited in claim 1, wherein the user interface is produced by the second application program.

8. A method as recited in claim 1, wherein said method is performed by the second application program.

9. A method as recited in claim 1, wherein the data communication file is a markup language document.

10. A method as recited in claim 9, wherein the markup language document is an XML document.

11. A method as recited in claim 1, wherein data within the data communication file pertains to media items managed by the first application program.

12. A method as recited in claim 1, wherein the data within the data communication file includes at least media item properties and links to storage locations for media content files containing media content for the media items.

13. A method as recited in claim 1, wherein said producing (b), said receiving (c), said identifying (d) and said associating (e) are each able to be performed regardless of whether the first application program is being executed by the computer system.

14. A method as recited in claim 1, wherein said first application program is a music manager and player, and wherein said second application program is an image or video manager and viewer.

15. A computer readable medium including at least computer program code for sharing media data between application programs operating on at least one a computer system, said computer readable medium comprising:
computer program code for accessing, by a second application program, a data communication file provided by a first application program;
computer program code for producing a user interface using data from the data communication file;
computer program code for receiving a user selection with respect to the user interface;
computer program code for identifying a media content file associated with the user selection; and
computer program code for associating a media content file identified by the user selection to the second application program.

16. A method as recited in claim 15,
wherein the data within the data communication file includes a link to the media content file, and
wherein the media content file is stored by the first application program, and thereafter the media content file is useable by the second application program.

17. A computer readable medium as recited in claim 15, wherein said computer program code for associating comprises presenting the media content file at the computer system.

18. A computer readable medium as recited in claim 15, wherein the user interface includes at least a list of media items determined from data acquired from the data communication file provided by the first application program.

19. A computer readable medium as recited in claim 15, wherein the data communication file is a markup language document.

20. A computer readable medium as recited in claim 19, wherein the markup language document is an XML document.

21. A computer readable medium as recited in claim 15, wherein data within the data communication file pertains to media items managed by the first application program.

22. A computer readable medium as recited in claim 15, wherein the data within the data communication file includes at least media item properties and links to storage locations for media content files containing media content for the media items.

23. A computer readable medium as recited in claim 15, wherein said computer program code for producing, said computer program code for receiving, said computer program code for identifying and said computer program code for associating are part of the second application program and are each able to be performed regardless of whether the first application program is being executed by the computer system.

24. A computer readable medium as recited in claim 15, wherein said first application program is a music manager and player, and wherein said second application program is an image or video manager and viewer.
Wherein the data communication file is stored on any of a first application program, a second application program or a third application program.

25. A computer readable medium as recited in claim 15, wherein the first application program executes on a first computer system, the second application program executes on a second computer system.

26. A computer readable medium as recited in claim 15, wherein the data communication file is stored on the first computer system, the second computer system, or another computer system.

27. A computer system for sharing media data between application programs operating thereon, said computer system comprising:
a first application program that manages a first media database that contains at least media information pertaining to media items, said first application further produces a database data communication file that includes at least a portion of the media information of the first media database;
a data storage device that stores the database data communication file and a media content file for each of a plurality of media items; and
a second application program that presents a user interface using at least a portion of the media information acquired from the database data communication file.

28. A computer system as recited in claim 27, wherein said second application program receives a user selection with respect to the user interface, thereby selecting at least one media item.

29. A computer system as recited in claim 28, wherein said second application program plays or displays media content from the media content file for the selected media item.

30. A computer system as recited in claim 28, wherein said second application program makes use of the media information from the database data communication file or media content from the media content file for the selected media item.

31. A computer system as recited in claim 27, wherein the database data communication file is a markup language document.

32. A computer system as recited in claim 31, wherein the markup language document is an XML document.

33. A computer system as recited in claim 27, wherein the user interface includes at least a list of certain of the media items affiliated with the first media database.

34. A computer system as recited in claim 33, wherein the list is a menu.

35. A computer system as recited in claim 27, wherein said data storage device further stores data forming the first media database.

36. A computer system as recited in claim 27, wherein said first application program updates the database data communication file whenever the first media database is updated.

37. A computer system as recited in claim 27, wherein said first application program updates the database data communication file when the first media database is changed.

38. A computer system as recited in claim 27, wherein said first application program updates the database data communication file when a user interface window associated with the first application program is context switched into a foreground position.
